(19) United States
(12) Patent Application Publication
(10) Pub. No.: US 2015/0249812 A1
(43) Pub. Date: Sep. 3, 2015

(54) STEREOSCOPIC IMAGE PROCESSING DEVICE, STEREOSCOPIC IMAGE PROCESSING METHOD, AND RECORDING MEDIUM

(71) Applicants: Sharp Kabushiki Kaisha, Osaka-shi, Osaka (JP); Kochi University of Technology, Kami-shi, Kochi (JP)

(72) Inventors: Ikuko Tsubaki, Osaka-shi (JP); Mikio Seto, Osaka-shi (JP); Hisao Kumai, Osaka-shi (JP); Hiroaki Shigemasu, Kami-shi (JP)

(73) Assignee: Kochi University of Technology, Karni-shi, Kochi (JP)

(21) Appl. No.: 14/425,123

(22) PCT Filed: Aug. 30, 2013
(86) PCT No.: PCT/JP2013/073260

§ 371 Date: Mar. 2, 2015

(30) Foreign Application Priority Data
Sep. 6, 2012 (JP) 2012-196220

(51) Int. Cl. H04N 13/00

(52) U.S. Cl. CPC H04N 13/0022; H04N 13/0018

(57) ABSTRACT

In a stereoscopic image processing device, disparity distribution of a stereoscopic image can be adaptively transformed in accordance with visual characteristics of a person relating to stereoscopic vision. The stereoscopic image processing device includes a disparity distribution transformation section (30) that transforms disparity distribution of a stereoscopic image input by an input section (10). The disparity distribution transformation section (30) reduces a difference in disparity between adjacent pixels in an area of the stereoscopic image, in which the difference in disparity between the adjacent pixels is large.

### TECHNICAL FIELD

The present invention relates to a stereoscopic image processing device, a stereoscopic image processing method, and a program of processing a stereoscopic image.

### BACKGROUND ART

Recently, stereoscopic display has been realized by providing different images for the right and left eyes of a person and thus the person perceives a three-dimensional sensation by a disparity in a technology used for an image display device displaying a stereoscopic image. Here, the disparity refers to a shift of an object between an image for the right eye and an image for the left eye regarding the object being in both of the images for the right and left eyes. An example of a problem in stereoscopic display includes that if there is a large amount of disparity to the extent of exceeding an allowable range of visual characteristics of a person, it is difficult to realize stereoscopic vision and thus a user is caused to feel tiredness or displeasure.

In PTL 1, a method of controlling disparity distribution of an input image to be in a predetermined range by performing a shift process and performing a scale-in process is disclosed, in the shift process, relative positions of images for the right and left eyes are shifted in a horizontal direction, and in the scale-in process, the images for the right and left eyes are expanded or reduced by using the centers of the images for the right and left eyes subjected to such image transformation as references.

### CITATION LIST

### Patent Literature

PTL 1: Japanese Unexamined Patent Application Publication No. 2011-55022 Non Patent Literature
NPL 1: SHIGEMASU Hiroaki and SATO Takao, “The Mechanism of Cardboard Cut-out Phenomenon”, Transactions of the Virtual Reality Society of Japan 10(2), pp. 249-256, 2005.

### SUMMARY OF INVENTION

### Technical Problem

The fact has been known that if there is discontinuous depth variation between objects in stereoscopic vision, perception of continuous depth variation in the object is suppressed and thus it is likely to feel an artificial three-dimensional sensation (see NPL 1). However, these visual characteristics and the artificial three-dimensional sensation have not been considered in a disparity adjusting technology of the related art, which includes the technology disclosed in PTL 1.

Considering such circumstances, an object of the present invention is to provide a stereoscopic image processing device, a stereoscopic image processing method, and a program for stereoscopic image processing which are capable of adaptively transforming disparity distribution of a stereoscopic image in accordance with visual characteristics of a person relating to stereoscopic vision.

### Solution to Problem

To solve the problem, according to a first aspect of the present invention, there is provided a stereoscopic image processing device that transforms disparity distribution of a stereoscopic image. The stereoscopic image processing device includes a transformation processing section that performs reduction processing of reducing a difference in disparity between adjacent pixels in an area of the stereoscopic image, in which the difference in disparity between the adjacent pixels is large.

According to a second aspect of the present invention, in the first aspect, the transformation processing section performs the reduction processing by reducing a disparity value of a pixel of which the disparity value is more than that of a vicinal pixel in the vicinity of a pixel in which the difference in disparity between adjacent pixels is large.

According to a third aspect of the present invention, in the first or second aspect, the transformation processing section performs the reduction processing by increasing a disparity value of a pixel of which the disparity value is smaller than that of a vicinal pixel in the vicinity of a pixel in which the difference in disparity between adjacent pixels is large.

According to a fourth aspect of the present invention, in any one of the first to third aspects, the transformation processing section performs disparity range adjustment processing of adjusting a range of a disparity included in the stereoscopic image.

According to a fifth aspect of the present invention, there is provided a stereoscopic image processing method that transforms disparity distribution of a stereoscopic image. The stereoscopic image processing method includes a step of reducing a difference in disparity between adjacent pixels in an area of the stereoscopic image, in which the difference in disparity between the adjacent pixels is large.

According to a sixth aspect of the present invention, there is provided a program for causing a computer to perform disparity distribution transformation processing of transforming disparity distribution of a stereoscopic image. The disparity distribution transformation processing includes a step of reducing a difference in disparity between adjacent pixels in an area of the stereoscopic image, in which the difference in disparity between the adjacent pixels is large.

### Advantageous Effects of Invention

According to the present invention, disparity distribution of a stereoscopic image can be adaptively transformed in accordance with visual characteristics of a person relating to stereoscopic vision. Thus, it is possible to prevent an artificial three-dimensional sensation which is scarce in continuous depth variation. With this, it is possible to provide a viewer with a good three-dimensional sensation.

### BRIEF DESCRIPTION OF DRAWINGS

FIG. 1 is a block diagram illustrating a configuration example of a stereoscopic image display device including a stereoscopic image processing device according to an embodiment of the present invention.

FIG. 2A is a diagram illustrating an example of a disparity map input to a disparity distribution transformation section of FIG. 1.

FIG. 2B is a diagram obtained as a graph by representing disparity values of a line corresponding to a dot line in the disparity map of FIG. 2A in coordinates of a vertical axis indicating a disparity value and a horizontal axis indicating a horizontal direction.

FIG. 2C is a diagram illustrating an example of the disparity map for each line subjected to processing on FIG. 2B performed by a disparity range adjustment unit.

FIG. 2D is a diagram illustrating an example of the disparity map for each line subjected to processing on FIG. 2C performed by a disparity map smoothing unit.

FIG. 3 is a flowchart illustrating a processing example of an image generation section in the stereoscopic image display device of FIG. 1.

### DESCRIPTION OF EMBODIMENTS

A stereoscopic image processing device according to the present invention includes a transformation processing section which performs reduction processing of reducing a difference in disparity between adjacent pixels in an area of the stereoscopic image, in which the difference in disparity between the adjacent pixels is large. That is, the stereoscopic image processing device according to the present invention is a device which can realize disparity adjustment such as transformation of disparity distribution (that is, depth of each subject) of a stereoscopic image by reducing a difference between disparity values at an edge (an area in which the disparity value varies discontinuously) of an object.

Hereinafter, an embodiment according to the present invention will be described in detail with reference to the accompanying drawings.

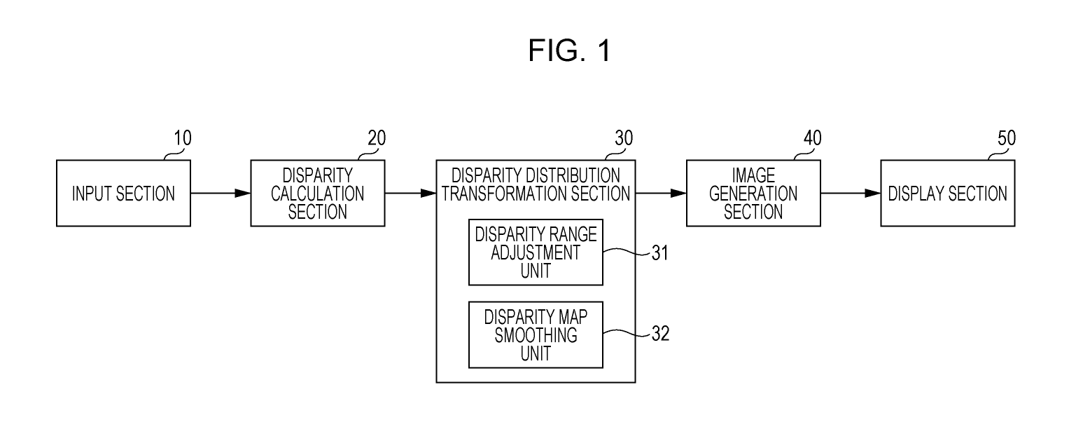

FIG. 1 is a block diagram illustrating a configuration example of a stereoscopic image display device including the stereoscopic image processing device according to the embodiment of the present invention.

As illustrated in FIG. 1, the stereoscopic image display device according to the embodiment includes an input section 10, a disparity calculation section 20, a disparity distribution transformation section 30, an image generation section 40, and a display section 50. A stereoscopic image which is formed from a plurality of viewpoint images is input to the input section 10. The disparity calculation section 20 sets one of the plurality of viewpoint images as a reference viewpoint image and sets remaining viewpoint images as separate viewpoint images, and calculates a disparity map from the reference viewpoint image and the separate viewpoint images. The disparity distribution transformation section 30 changes (transforms) disparity distribution of the stereoscopic image by changing the disparity map obtained by the disparity calculation section 20. The image generation section 40 reconstructs the separate viewpoint images from the reference viewpoint image and disparity distribution obtained through transformation of the disparity distribution transformation section 30. The display section 50 performs three-dimensional display in a binocular manner or a multi-view manner by using the reference viewpoint image and the separate viewpoint images generated by the image generation section 40.

The disparity distribution transformation section 30 is an example of the transformation processing section corresponding to a main point of the present invention. Thus, the stereoscopic image processing device according to the present invention, which includes this embodiment may include at least the disparity distribution transformation section 30 among the sections 10, 20, 30, 40, and 50 and thus may transform disparity distribution of a stereoscopic image. The disparity distribution transformation section 30 in the present invention may perform transformation of the disparity distribution by using other methods other than transforming the disparity map.

Hereinafter, each section of the stereoscopic image display device according to the embodiment will be described in detail.

The input section 10 receives data (stereoscopic image data) of a stereoscopic image and outputs a reference viewpoint image and a separate viewpoint image from the input stereoscopic image data. Here, the input stereoscopic image data may be any one of data obtained by performing capturing with a camera, data obtained from a broadcast wave, data electronically read from a local storage device or a portable recording medium, data obtained from an external server or the like through communication, and the like.

When the display section 50 performs the three-dimensional display in the binocular manner, the stereoscopic image data is formed from image data for the right eye and image data for the left eye. When the display section 50 performs the three-dimensional display in the multi-view manner, the stereoscopic image data is multi-viewpoint image data for display in the multi-view manner, which is formed from three viewpoint images or more. When the stereoscopic image data is formed from the image data for the right eye and the image data for the left eye, one piece of image data is used as a reference viewpoint image and another piece of image data is used as a separate viewpoint image. When the stereoscopic image data is the multi-viewpoint image data, one of the plurality of viewpoint images is referred to as a reference viewpoint image and remaining viewpoint images are referred to as separate viewpoint images.

The description of FIG. 1 and the following descriptions are premised basically on the assumption that the stereoscopic image data is formed from data of the plurality of viewpoint images. However, the stereoscopic image data may be formed from image data and depth data or from the image data and disparity data. In this case, the depth data or the disparity data is input as the separate viewpoint image from the input section 10. However, the image data may be used as the reference viewpoint image and the depth data or the disparity data may be used as the disparity map. In a case of such a configuration, the disparity calculation section 20 is unnecessary and the disparity distribution transformation section 30 changes the disparity map input by the input section 10, and thus the disparity distribution of the stereoscopic image may be changed (transformed) in the stereoscopic image display device of FIG. 1. When a format of the disparity map is not a processable format in the image generation section 40, the disparity calculation section 20 may be provided and the disparity calculation section 20 may convert the format of the disparity map into the processable format. In the following descriptions, a case of using the depth data or the disparity data will be described simply and supplementarily.

The disparity calculation section 20 calculates a disparity map of the reference viewpoint image and the remaining viewpoint images, that is, calculates a disparity map of each of the separate viewpoint images based on the reference viewpoint image in this example. The disparity map is one that plots difference values of coordinates in a transverse direction (horizontal direction) between each pixel of the separate viewpoint image and the corresponding point in the reference viewpoint image. That is, the disparity map plots difference values of coordinates in the transverse direction between each pixel in one stereoscopic image and the corresponding pixel in another stereoscopic image. The disparity value is set to become larger along a direction closer to the front and set to become smaller along a depth direction.

Various approaches of using block matching, dynamic programming, graph cut and the like are known as disparity map calculation methods and any one of the various approaches may be used. In addition, only a disparity in the transverse direction is described, but calculation of a disparity map or transformation of disparity distribution in the longitudinal direction may be performed similarly if there is also a disparity in a longitudinal direction.

The disparity distribution transformation section 30 includes a disparity range adjustment unit 31 and a disparity map smoothing unit 32. The disparity range adjustment unit performs conversion of a value of the disparity map in accordance with a range of values of a disparity map D(x, y) obtained by the disparity calculation section 20 such that the values of the disparity map are in a predetermined range. First, the maximum value dmax and the minimum value dmin of disparity values in the disparity map are calculated. Then, a disparity map D′(x,y) after disparity range adjustment is obtained by using linear conversion of Expression (1) as follows with the use of the maximum value Dmax and the minimum value Dmin in a desired disparity range.

$${D}^{′} ( x , y ) = \frac{D max - D min}{d max - d min} ( D ( x , y ) - d min ) + D min \qquad ( 1 )$$

Dmax and Dmin are constants for satisfying an expression of Dmax≧Dmin which is given in advance. D′(x, y)=Dmax in a case of dmax=dmin.

The disparity map D′(x, y) after disparity range adjustment is converted through processing of Expression (1) such that the disparity range has the maximum value Dmax and the minimum value Dmin. Dmax and Dmin are specified considering a disparity range determined to reduce tiredness of a user when the user performs watching and thus an effect of performing adjustment to a disparity range which allows tiredness to be reduced works in such disparity range adjustment processing.

The disparity distribution transformation section 30 preferably performs the disparity range adjustment processing of adjusting a range of a disparity included in the stereoscopic image because such an effect works. The disparity distribution transformation section 30 may include the disparity map smoothing unit 32 which will be described next and the disparity distribution transformation section 30 may or may not include the disparity range adjustment unit 31.

The disparity map smoothing unit 32 performs main processing in the transformation processing section. That is, the disparity map smoothing unit 32 performs the reduction processing of reducing a difference between adjacent pixels in an area in which the difference in disparity between the adjacent pixels is large. The disparity map smoothing unit 32 performs this reduction processing through smoothing processing of smoothing the disparity map. It is preferable that in this reduction processing a difference between adjacent pixels is reduced only in an area in which the difference in disparity between the adjacent pixels is greater than a predetermined value, and an example like this is described. Reduction may also be performed in an area in which a difference in disparity between adjacent pixels is equal to or less than the predetermined value. In this case, reduction may be performed to reduce more in the area in which a difference in disparity between adjacent pixels is large, compared to reduction in the area in which a difference in disparity between adjacent pixels is small. In addition, only a configuration in which the disparity distribution transformation section 30 includes the disparity range adjustment unit 31 is described. However, a disparity map to be smoothed is set as the disparity map D(x, y) in a configuration in which the disparity range adjustment unit 31 is not included.

In this example, the disparity map smoothing unit 32 performs smoothing by the filtering processing as represented in Expression (2). If a disparity map after adjustment, which is obtained by the disparity range adjustment unit 31 is set to D′(x, y), a filter coefficient is set to g, and a window size is set to “2 w+1”, a disparity value D″(x, y) after smoothing is represented by the following expression.

$${D}^{″} ( x , y ) = {\sum }_{i = - w}^{w} {\sum }_{j = - w}^{w} g ( i , j ) \cdot f ( {D}^{′} ( x , y ) , {D}^{′} ( x + i , y + j ) ) \\ f ( {d}_{1} , {d}_{2} ) = \{ \begin{matrix}{d}_{2} \text{:} {d}_{1} - {d}_{2} \geq ɛ \\ {d}_{1} \text{:} {d}_{1} - {d}_{2} < ɛ\end{matrix} \\ g ( i , j ) = \frac{1}{M} exp ( - \frac{{i}^{2} + {j}^{2}}{2 {σ}^{2}} ) \\ M = {\sum }_{i = - w}^{w} {\sum }_{j = - w}^{w} exp ( - \frac{{i}^{2} + {j}^{2}}{2 {σ}^{2}} ) \qquad ( 2 )$$

ε refers to a positive constant for determining whether or not the disparity value is continuous. Expression (2) corresponds to a non-linear smoothing filter operating in such a manner that a difference “d₁−d₂” between a disparity value in a certain pixel (x, y) and a disparity value in a pixel (x+i, y+j) vicinal to the pixel (x, y) is obtained, the obtained difference is compared to a value of threshold e, the vicinal pixel is used for smoothing when the obtained difference is equal to or more than the threshold, and the vicinal pixel is not used for smoothing when the obtained difference is smaller than the threshold. The difference “d₁−d₂” being equal to or more than the threshold means that the pixel (x, y) is closer to the front than the vicinal pixel (x+i, y+j) and a difference in disparity between the two pixels is large. When a vicinal pixel which makes the difference “d₁−d₂” be equal to or more than the threshold is not in a window, smoothing is not performed on the pixel. In this manner, since only a vicinal pixel which makes a difference be equal to or more than the threshold is used in smoothing, an effect of reducing a disparity value of a pixel having a large disparity compared to a vicinal pixel is obtained. As a result, a difference between adjacent pixels is reduced. σ is a constant for controlling characteristics of the filter. The disparity distribution transformation section 30 outputs the disparity map D″(x, y) after smoothing, which is obtained through Expression (2) as a disparity map after conversion processing.

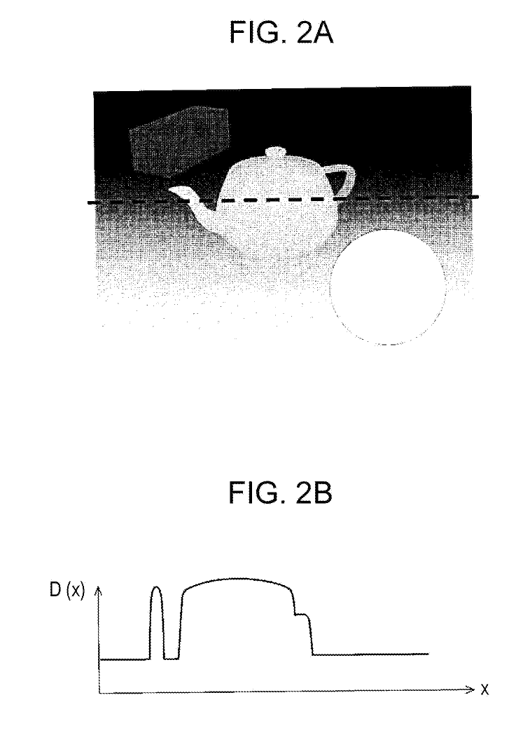

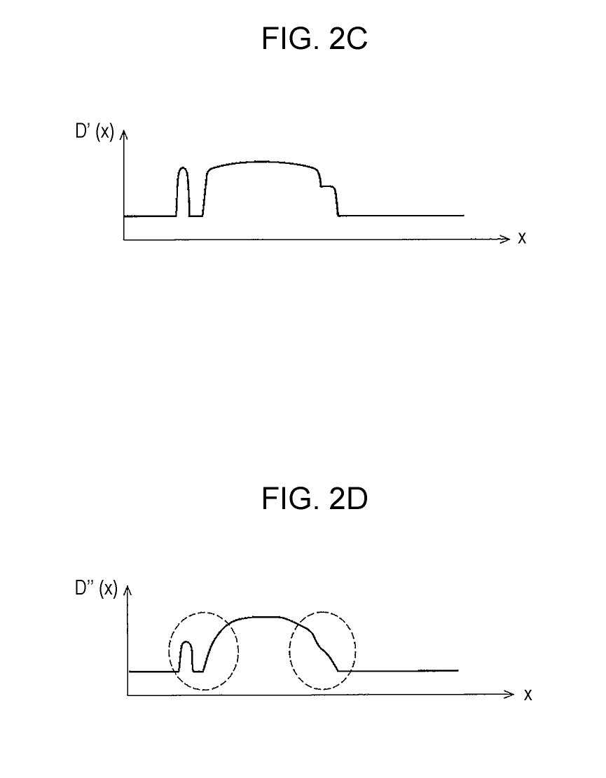

Next, an example of disparity distribution transformation processing in the embodiment will be described using a specific example of the disparity map. FIG. 2A illustrates an example of a disparity map calculated by the disparity calculation section 20 and FIG. 2B illustrates a graph of a disparity in a certain line (portion corresponding to the dot line in FIG. 2A) of the disparity map in FIG. 2A.

More specifically, descriptions of FIG. 2A and FIG. 2B will be made. The disparity map illustrated in FIG. 2A assigns a disparity value calculated in each pixel to a luminance value. Accordingly, spatial distribution of disparity values in a stereoscopic image is expressed by assigning a large luminance value along the direction closer to the front and assigning a small luminance value along the direction further from the front. FIG. 2B is a graph representing disparity values at the line corresponding to the dot line in the disparity map of FIG. 2A in coordinates of a vertical axis indicating a disparity value (large disparity value in the direction closer to the front and small disparity value in the depth direction) and a horizontal axis indicating a horizontal direction. The minimum value of the disparity values is depicted as a transverse axis (axis in a horizontal direction coordinate), for convenience, in FIG. 2B. However, the disparity value in the depth direction is a negative value and the disparity value in the direction closer to the front is a positive value. In this example, disparity distribution is transformed based on the disparity value for each line expressed in the graph of FIG. 2B.

FIG. 2C illustrates an example of a result obtained by performing processing of the disparity range adjustment unit 31 on such disparity values in FIG. 2B. In FIG. 2C, the disparity range is reduced, compared to FIG. 2B. FIG. 2D illustrates an example of a result obtained by performing processing of the disparity map smoothing unit 32 on such disparity values in FIG. 2C using Expression (2). In FIG. 2D, areas surrounded by dot lines refer to the areas in which the difference between the adjacent pixels is large, in FIG. 2C. However, variation of the disparity values becomes smooth and the difference between the adjacent pixels is reduced in FIG. 2D. In an example of FIG. 2D, correction is performed in such a manner that the disparity values are reduced. Since variation hardly occurs in an area except for the areas surrounded by the dot lines, the maximum value and the minimum value are not changed compared to FIG. 2C.

The disparity map smoothing unit 32 may perform the reduction processing of reducing a difference between adjacent pixels in an area in which the difference in disparity between the adjacent pixels is large, in addition to disparity value conversion processing as described above. For example, correction is performed in such a manner that the disparity values are increased, differently from FIG. 2D, and f in Expression (2) may be replaced with Expression (3). For example, correction is performed in such a manner that the disparity values are reduced and that the disparity values are increased and f in Expression (2) may be replaced with Expression (4).

$$\begin{matrix}f ( {d}_{1} , {d}_{2} ) = \{ \begin{matrix}{d}_{2} \text{:} {d}_{2} - {d}_{1} \geq ɛ \\ {d}_{1} \text{:} {d}_{2} - {d}_{1} < ɛ\end{matrix} & ( 3 ) \\ f ( {d}_{1} , {d}_{2} ) = \{ \begin{matrix}{d}_{2} \text{:} \vert {d}_{1} - {d}_{2} \vert \geq ɛ \\ {d}_{1} \text{:} \vert {d}_{1} - {d}_{2} \vert < ɛ\end{matrix} & ( 4 )\end{matrix}$$

The disparity distribution transformation section 30 preferably performs the reduction processing by changing (reducing) a disparity value of a pixel having the disparity value greater than that of a vicinal pixel and/or by changing (increasing) a disparity value of a pixel having the disparity value smaller than that of a vicinal pixel, in the vicinity of a pixel which makes a difference in disparity between adjacent pixels large, as Expressions (2) to (4) are exemplified as f in the disparity map smoothing unit 32.

An example of the reduction processing is not limited to D″(x, y) in Expression (2) and other smoothing filters may be used as the example of the reduction processing. The reduction processing may be processing in which a difference between adjacent pixels is reduced in an area in which the difference in disparity between the adjacent pixels is large and disparity values are changed little in other areas.

When a stereoscopic image is formed by two viewpoint images, the disparity distribution transformation section 30 transforms disparity distribution obtained by using the two viewpoint images. When the stereoscopic image is formed of three viewpoint images or more, such detection and transformation processing may be performed between a determined viewpoint image (reference viewpoint image) and each of other plurality of viewpoint images.

Returning to FIG. 1, processing after disparity distribution transformation will be described. The image generation section 40 reconstructs the separate viewpoint image from the reference viewpoint image and the disparity map after transformation of the disparity distribution transformation section 30. The reconstructed separate viewpoint image is referred to as a separate viewpoint image for display. More specifically, the image generation section 40 reads a disparity value in the corresponding coordinates from the disparity map in each pixel of the reference viewpoint image. The image generation section 40 copies a pixel value in the separate viewpoint image to be reconstructed to an image obtained by shifting the coordinates by the disparity value. This processing is performed on all the pixels in the reference viewpoint image. However, a pixel value of a pixel having the maximum disparity value in the direction closer to the front is used based on a z buffer method when a plurality of pixel values is allocated to the same pixel.

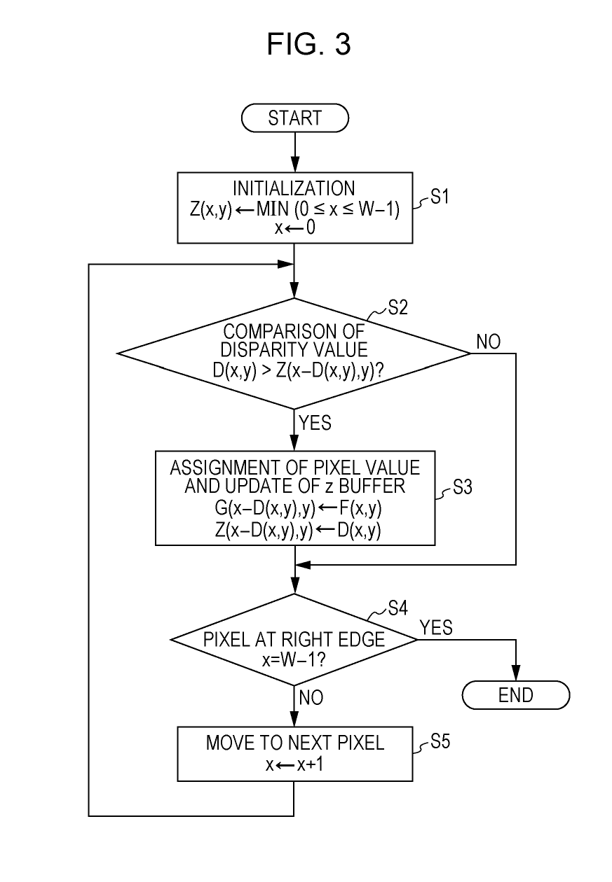

An example of reconstruction processing of the separate viewpoint image in the image generation section 40 will be described with reference to FIG. 3. FIG. 3 is an example when an image for the left eye is selected as the reference viewpoint image. (x, y) indicates coordinates in an image, but (x, y) in FIG. 3 corresponds to processing in each line and y is constant. F, G, and D indicate the reference viewpoint image, the separate viewpoint image for display, and the disparity map, respectively. Z refers to an array for holding a disparity value of each pixel in the separate viewpoint image for display in the process of performing processing and Z is referred to as a z buffer. W indicates the number of pixels of the image in the transverse direction.

First, in Step S1, the z buffer is initialized to have an initial value MIN. A disparity value is set in such a manner that the disparity value is a positive value in a case of the direction closer to the front and is a negative value in a case of the depth direction. MIN has a value smaller than the minimum value in disparity converted by the disparity distribution transformation section 30. Since processing is performed in an order from the leftmost pixel, in the subsequent steps, 0 is input to x. In Step S2, a disparity value of the disparity map is compared to a value of the z buffer in a pixel obtained by moving the coordinates by the disparity value and it is determined whether or not the disparity value is greater than the value of the z buffer. When the disparity value is greater than the value of the z buffer, the process proceeds to Step S3 and the pixel value of the reference viewpoint image is assigned to the separate viewpoint image for display. The value of the z buffer is updated.

Then, in Step S4, when current coordinates refer to the right edge pixel, the process is ended. When the current coordinates do not refer to the right edge pixel, the process proceeds to Step S5, moving to the rightward next pixel is performed and the process returns to Step S2. In Step S2, when the disparity value is equal to or less than the value of the z buffer, the process does not pass through Step S3 and proceeds to Step S4. These procedures are performed on all lines.

In the stereoscopic image display device according to the embodiment, the image generation section 40 performs interpolation processing on a pixel to which a pixel value is not assigned and thus assigns the pixel value to the pixel. That is, the image generation section 40 includes an image interpolation unit such that the pixel value may be determined normally. The interpolation processing is performed by using the average value of a pixel value of a pixel-value assignment completion pixel nearest to a pixel-value not-assignment pixel on the left side of the pixel value not-assignment pixel and a pixel value of a pixel-value assignment completion pixel nearest to a pixel-value not-assignment pixel on the right side of the pixel value not-assignment pixel. Here, using the average value of pixel values of vicinal pixels is present as the interpolation processing. However, the interpolation processing is not limited to a method of using the average value and weighting depending on a distance between pixels may be performed. In addition, other methods such as other filtering processing may be employed.

The display section 50 is configured by a display device and a display control unit. The display control unit controls output of a stereoscopic image which includes a separate viewpoint image for display generated by the image generation section 40 and the reference viewpoint image as display components. That is, the display section 50 receives the reference viewpoint image and the generated separate viewpoint image for display and displays the received images three-dimensionally in the binocular manner or the multi-view manner. When an image for the left eye is set as the reference viewpoint image in the input section 10 and an image for the right eye is set as the separate viewpoint image, the reference viewpoint image is displayed as the image for the left eye and the separate viewpoint image for display is displayed as the image for the right eye. When the image for the right eye is set as the reference viewpoint image in the input section 10 and the image for the left eye is set as the separate viewpoint image, the reference viewpoint image is displayed as the image for the right eye and the separate viewpoint image for display is displayed as the image for the left eye.

When an image input to the input section 10 is a multi-viewpoint image, the reference viewpoint image and the separate viewpoint image for display are displayed side by side in the same order as the order of inputting images. When image data input to the input section 10 includes image data and depth data or includes the image data and disparity data, determination is performed in accordance with a setting regarding the image data is used as which one of the images for the right and left eyes.

According to processing in the embodiment, suppressing discontinuous variation in depth causes perception of continuous variation in depth (continuous variation in depth in an object) to be suppressed and thus it is possible to prevent occurrence of an artificial three-dimensional sensation and to display an image having a natural three-dimensional sensation.

That is, according to the embodiment, it is possible to adaptively transform disparity distribution of a stereoscopic image in accordance with visual characteristics of a person relating to stereoscopic vision.

Adjustment of an extent (for example, each parameter in each of the above-described manners) of changing (adjusting) the disparity distribution of a stereoscopic image corresponds to adjustment of a disparity amount of stereoscopic image in the stereoscopic image display device according to the embodiment. Such a changing extent may be operated from an operation section by a viewer or may be determined in accordance with a default setting. Changing may be performed in accordance with the disparity distribution. Additionally, the changing extent may be changed in accordance with a parameter such as a genre or image features (for example, average luminance of viewpoint images constituting the stereoscopic image) of a stereoscopic image, other than a disparity of the stereoscopic image. In the present invention, the reduction processing may be performed in which a difference in disparity between adjacent pixels is reduced in accordance with whether or not a certain area is an area in which discontinuous variation in depth between objects is large (in accordance with visual characteristics of a person relating to stereoscopic vision as disclosed in NPL 1) in any case of adjustment such that perception of continuous variation in depth in an object is suppressed. Accordingly, it is possible to provide a good three-dimensional sensation in the present invention.

The stereoscopic image display device according to the present invention is described, but a configuration of a stereoscopic image processing device in which the display device is excluded from such a stereoscopic image display device may be employed in the present invention. That is, the display device for displaying a stereoscopic image as it is may be mounted in a main body of the stereoscopic image processing device according to the present invention and may be coupled to the outside of the device. Such a stereoscopic image processing device may be combined with a television device or a monitor device and may be combined with other image output device such as various recorders or various recording medium reproduction devices.

Some sections (that is, components except for the display device included in the display section 50) which correspond to the stereoscopic image processing device according to the present invention among the respective sections in the stereoscopic image display device illustrated in FIG. 1 may be implemented by, for example, hardware such as a microprocessor (or DSP: digital signal processor), a memory, a bus, an interface, and peripheral devices, and software allowed to be executed on the hardware. Some or the entirety of the hardware may be mounted as an integrated circuit (IC) such as a large scale integration (LSI)/an integrated circuit (IC) chipset. In this case, the software may be stored in the memory. All of the components in the present invention may be configured with hardware and similarly some or the entirety of the hardware may be also mounted as an integrated circuit (IC)/an integrated circuit (IC) chipset in this case.

In the above-described embodiment, the descriptions are made assuming that components for performing functions are parts different from each other. However, the parts which can be clearly separated and recognized may or may not be formed in practice. In the stereoscopic image processing device for performing functions according to the present invention, each component for performing a function may be configured by using different parts in practice or all components may be mounted on one integrated circuit/IC chipset. Each component as a function may be formed in any mounting form.

The stereoscopic image processing device according to the present invention may be simply configured with a central processing unit (CPU), a random access memory (RAM) as a working area, a read only memory (ROM) as a storage area of a control program, a storage device such as an electrically erasable programmable ROM (EEPROM), and the like. In this case, the control program may include a stereoscopic image processing program which is for executing processing according to the present invention and will be described later. The stereoscopic image processing program may be installed as an application for displaying a stereoscopic image, on a PC and may cause the PC to have a function as the stereoscopic image processing device. The stereoscopic image processing program may be stored in an external server such as a web server in a state where the program is allowed to be executed in a client PC.

Hitherto, the stereoscopic image processing device according to the present invention is mainly described, but a form of a stereoscopic image processing method may be employed in the present invention, as a control flow in the stereoscopic image display device including the stereoscopic image processing device is described. The stereoscopic image processing method is a method of transforming disparity distribution of a stereoscopic image and includes a step of reducing a difference between adjacent pixels in an area of the stereoscopic image, in which the difference in disparity between the adjacent pixels is large. Descriptions of other application examples are as with the descriptions of the stereoscopic image display device.

In the present invention, a form of a stereoscopic image processing program for causing a computer to execute the stereoscopic image processing method may be employed. That is, the stereoscopic image processing program is a program for causing the computer to execute the disparity distribution transformation processing of transforming disparity distribution of a stereoscopic image. The disparity distribution transformation processing includes a step of reducing a difference between adjacent pixels in an area of the stereoscopic image, in which the difference in disparity between the adjacent pixels is large. Descriptions of other application examples are as with the descriptions of the stereoscopic image display device.

In addition, a form of a program recording medium obtained by recording the stereoscopic image processing program on a computer readable recording medium may be easily understood. As the computer, as described above, computers of various forms such as a microcomputer or a programmable general-purpose integrated circuit/chipset may be applied in addition to a general PC. The program is not limited to be circulated through a portable recording medium and the program may be circulated through a network such as the Internet or circulated through a broadcast wave. Reception through the network indicates receiving the program stored in a storage device of an external server and the like.

### REFERENCE SIGNS LIST

10 INPUT SECTION
20 DISPARITY CALCULATION SECTION
30 DISPARITY DISTRIBUTION TRANSFORMATION SECTION
31 DISPARITY RANGE ADJUSTMENT UNIT
32 DISPARITY MAP SMOOTHING UNIT
40 IMAGE GENERATION SECTION
50 DISPLAY SECTION

1. A stereoscopic image processing device which transforms disparity distribution of a stereoscopic image, the device comprising:
a transformation processing section that performs reduction processing of reducing a difference in disparity between adjacent pixels in an area of the stereoscopic image, in which the difference in disparity between the adjacent pixels is large.

2. The stereoscopic image processing device according to claim 1, wherein
the transformation processing section performs the reduction processing by reducing a disparity value of a pixel of which the disparity value is more than that of a vicinal pixel in the vicinity of a pixel in which the difference in disparity between adjacent pixels is large.

3. The stereoscopic image processing device according to claim 1, wherein
the transformation processing section performs the reduction processing by increasing a disparity value of a pixel of which the disparity value is smaller than that of a vicinal pixel in the vicinity of a pixel in which the difference in disparity between adjacent pixels is large.

4. The stereoscopic image processing device according to claim 1, wherein
the transformation processing section performs disparity range adjustment processing of adjusting a range of a disparity included in the stereoscopic image.

5. A stereoscopic image processing method which transforms disparity distribution of a stereoscopic image, the method comprising:
a step of reducing a difference in disparity between adjacent pixels in an area of the stereoscopic image, in which the difference in disparity between the adjacent pixels is large.

6. A non-transitory computer readable recording medium in which a program for causing a computer to perform disparity distribution transformation processing of transforming disparity distribution of a stereoscopic image is recorded, wherein
the disparity distribution transformation processing includes a step of reducing a difference in disparity between adjacent pixels in an area of the stereoscopic image, in which the difference in disparity between the adjacent pixels is large.
